(19) United States
(12) Patent Application Publication
(10) Pub. No.: US 2010/0318791 A1
(43) Pub. Date: Dec. 16, 2010

(54) CERTIFICATE STATUS INFORMATION PROTOCOL (CSIP) PROXY AND RESPONDER

(75) Inventors: Rafie Shamsaasef, San Diego, CA (US); Alexander Medvinsky, San Diego, CA (US); Madjid F. Nakhjiri, San Diego, CA (US); Petr Peterka, San Diego, CA (US)

Correspondence Address: Motorola, Inc., 600 North US Highway 45, W4 - 39Q, Libertyville, IL, 60048-5343, US

(73) Assignee: GENERAL INSTRUMENT CORPORATION, Horsham, PA (US)

(21) Appl. No.: 12/814,554

(22) Filed: Jun. 14, 2010

Related U.S. Application Data
(60) Provisional application No. 61/186,498, filed on Jun. 12, 2009.

(51) Int. Cl. H04L 29/06

(52) U.S. Cl. 713/158; 713/156

(57) ABSTRACT

Systems and methods are disclosed for providing certificate status information about a certificate includes receiving, at a Certificate Status Information Protocol (CSIP) proxy device the certificate identity information about the certificate of the second device. Then determining, using the CSIP proxy device, whether the certificate status information is stored in a CSIP proxy device memory. If the certificate status information is not stored in the CSIP proxy device memory, creating a CSIP request based on the certificate identity information and sending the CSIP request, including the certificate identity information, to a CSIP responder computer outside the local network domain. If the certificate status information is stored in the CSIP proxy device memory, sending the certificate status information to the first device. Also, a system and method are disclosed for using a CSIP responder computer.

### PRIORITY

This application claims priority to U.S. Provisional Patent Application Ser. No. 61/186,498, filed Jun. 12, 2009, entitled “OCSP Proxy in Home Network”, by Shamsaasef et al., based on Attorney Docket No. BCS05754, which is incorporated by reference herein in its entirety.

### BACKGROUND

Pushing content over the Internet to view on a variety of different types of devices, such as mobile devices and devices for home entertainment, is becoming more and more prevalent. The distribution of content may include distribution over local area networks, such as home networks. In many instances, the distribution of content is restricted by download rights management (DRM) schemes and content protection requirements. These DRM schemes have been developed through different organizations concerned with maintaining sources of trust as a basis for sharing content among such devices.

One DRM scheme used among devices used in a home network, such as smart phones, DVD players and televisions, includes encrypting interconnections between the devices through a standard called Digital Transmission Content Protection, or the DTCP standard. The DTCP standard uses certificates for allowing content to be distributed between different devices if these different devices all implement the DTCP standard. The Digital Transmission Licensing Administrator (DTLA) was established in 1998 to simplify licensing procedures and promote acceptance of the DTCP standard by content providers, electronic device manufacturers, and broadcast service providers with in a home network.

The Digital Living Network Alliance (DLNA) was founded in 2003 by a consortium of electronic device manufacturers to promote interoperability between devices within home network by standardization of various guidelines. The DLNA Link Protection guideline requires DTCP over an internet protocol (“DTCP-IP”) as a basic and common link protection for all home devices deploying DLNA standard. Therefore it relies on certificates for use in consumer electronic devices which allow the devices within a home network to share their content across a home network domain. Other standards, and certificates with formats based on the other standards, are developed through the Alliance for Telecommunications Industry Solutions (ATIS), which is a standards organization that develops technical and operational standards for the telecommunication industry. ATIS is also a member organization of a number of other standards organizations.

Other DRM schemes can include the use of Certificate Authorities (CAs). The primary role of the CA is to issue and publish a certificate for a key pair assigned to a given user. This is done using the CA's own key, so that the trust in the user key relies on the trust based on the validity of the CA's key. The mechanism that binds a specific key to a specific user is performed by the Registration Authority (RA), which may or might not be separate from the CA publishing the user's key. Some content providers also control content access through proprietary DRM schemes. In May 2007, Microsoft established Windows Media DRM (WMDRM). WMDRM is a DRM service, relying on WMDRM certificates, for use with the Windows Media platform.

One area for consideration, in the implementation of DTCP over IP, DLNA and other standards, using certificates as a source of trust, is the process of device certificate revocation status verification. In a DLNA/DTCP-IP context, this process is done as part of system renewability messaging (SRM). SRM messages allow a device which shares content with other devices to update its list of revoked devices to mitigate the risk of engaging in content sharing with incompliant or compromised devices. However, the use of SRM messaging has introduced challenges to the adoption of any standard in a local network which relies on a different standard for a local network domain. So an example of two devices based on different standards in a local network domain is a device using DTCP-IP when it is introduced into a home network domain which uses another standard, such as DLNA.

Also using SRM for device certificate revocation status verification presents growing practical problems. The proliferation of devices depending on certificates for authorizing the sharing of content is distribution of ever larger list of revoked certificates in the SRM messages. A Certificate Revocation List (CRL) is a list of certificates, or more specifically, a list of serial numbers or some other type of certificate identification, for certificates which have been revoked, compromised or are no longer valid, and therefore should not be relied upon for authorizing the sharing of content. As the certificate revocation lists (CRL) grow larger, transporting them over local network domains with limited bandwidth is becoming less and less desirable. Some devices which share content may not have sufficient memory to store and process large CRLs, which can grow to many megabytes in size. So the devices may not have sufficient capacity to search the large CRLs for a revoked certificate status.

Also, devices relying on SRM require continuous connectivity with an infrastructure outside the local network domain for providing CRLs, such as CRL servers, in order for the devices to download updated CRLs or communicate the SRM message to another device. This process may not be practical for some devices which are isolated in a local network. Some devices, such as televisions may only occasionally or intermittently connect to an infrastructure outside of a home network or local network. So these devices do not have ready access to updated CRLs. These devices cannot always determine the revocation status of the certificates they receive in a timely manner before sharing content.

In addition, the SRM messaging format is not readily adaptable to an optimization of the process of device certificate revocation status verification, and the SRM messaging format limits adding additional data to expand its format. According to the existing scheme, SRM messages containing large amount of data can overflow a home network, or another local network, and otherwise consume excessive bandwidth in bringing a CRL into the network and in distributing it among content sharing devices in the network.

### BRIEF SUMMARY OF THE INVENTION

According to one embodiment, the disclosure provides a Certificate Status Information Protocol (CSIP) proxy device in a local network domain, configured to provide, through the local network domain to a first device in the local network domain, a second device certificate status information about a certificate of a second device, the CSIP proxy device including a data storage device configured to store, for a plurality of devices, a certificate status information about certificates of the plurality of devices, and a processor configured to receive, from the first device, a second device certificate identity information about the certificate of the second device, determine whether the second device certificate status information is stored in the data storage device, if the second device certificate status information is not stored in the data storage device, create a CSIP request based on the second device certificate identity information and send the CSIP request to a CSIP responder computer outside the local network domain; and if the second device certificate status information is stored in the data storage device, send the second device certificate status information to the first device.

According to another embodiment, the disclosure provides a method for providing, through a local network domain to a first device in the local network domain, a second device certificate status information about a certificate of a second device, the method including receiving, at a Certificate Status Information Protocol (CSIP) proxy device in the local network domain, a second device certificate identity information about the certificate of the second device, determining, using the CSIP proxy device, whether the second device certificate status information is stored in a CSIP proxy device memory, if the second device certificate status information is not stored in the CSIP proxy device memory, creating a CSIP request based on the second device certificate identity information and sending the CSIP request, to a CSIP responder computer outside the local network domain, and if the second device certificate status information is stored in the CSIP proxy device memory, sending the second device certificate status information to the first device.

According to another embodiment, the disclosure provides a Certificate Status Information Protocol (CSIP) responder computer outside a local network domain, configured to provide a CSIP response including a certificate status information, to a CSIP proxy device in the local network domain, the CSIP responder computer including a data storage device configured to store, for a plurality of devices inside a plurality of local network domains, a plurality of certificate status information about a plurality of certificates for the plurality of devices in the plurality of local network domains; and a processor configured to receive from a Certificate Licensing Authority (CLA), a Certificate Revocation List (CRL) or a Certificate Authority (CA), the plurality of certificate status information about the plurality of certificates, wherein the received plurality of certificate status information are in a format determined by the CLA, the CRL or the CA, convert the received plurality of certificate status information from the received individual format to a CSIP format certificate status information, store the CSIP format certificate status information in the data storage device; and send the CSIP format certificate status information in a CSIP response to the CSIP proxy device in the local network domain.

According to still another embodiment, the disclosure provides a method for providing a certificate status information about a certificate of a device to a Certificate Status Information Protocol (CSIP) proxy device in a local network domain, the method including locating a Certificate Licensing Authority (CLA) or a Certificate Authority (CA), responsible for providing a Certificate Revocation List (CRL) or other revocation information for the certificate, receiving from the CLA or CA, a CRL, including the certificate status information about the certificate, wherein the received certificate status information is in a format determined by the CLA, the CA or the CRL, converting the received certificate status information from the received format to a CSIP format, storing the CSIP format certificate status information in a CSIP responder computer memory, and sending the CSIP format certificate status information in a CSIP response to the CSIP proxy device in the local network domain.

The embodiments described above provide the advantage of allowing the use of a Certificate Status Information Protocol (CSIP) proxy device within a local network to improve the capability of device certificate revocation status checking for devices in a local network without a need for downloading large CRLs into the local network for the devices in the network. The embodiments also provide the advantage of removing the need for regular or constant connectivity, of devices in the local network, to the Internet and/or to other infrastructure, which is external to the local network for providing CRLs, such as a CRL server. This also reduces the significant delays associated with two-way communications between a device and a CRL server. Embodiments directed to a CSIP proxy including a CSIP proxy memory also provide the advantage of reducing the level of connectivity to the CSIP responder, by using the certificate status information in CSIP proxy memory for at least part of the certificate revocation status verification process, rather than accessing the CSIP responder. Another advantage relates to the use of CSIP protocol for enhancing the communications involving certificates based on different standards.

### BRIEF DESCRIPTION OF DRAWINGS

Embodiments will be described in detail in the following description with reference to the following figures.

FIG. 1 illustrates a system, according to an embodiment;

FIG. 2 illustrates a process flowchart demonstrating a method, according to an embodiment;

FIG. 3 illustrates another process flowchart demonstrating a method, according to an embodiment; and

FIG. 4 illustrates a computer system configured to provide a hardware platform for the CSIP proxy 101 shown in FIG. 1, according to an embodiment; or a computer system configured to provide a hardware platform for the CSIP responder 107 also shown in FIG. 1, according to an embodiment.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments. Furthermore, different embodiments are described below. The embodiments may be used or performed together in different combinations.

### 1. SYSTEM

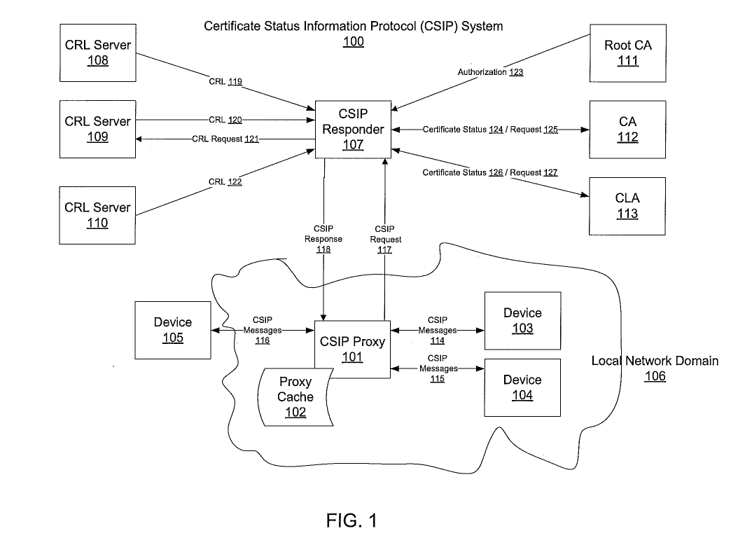

FIG. 1 shows a Certificate Status Information Protocol (CSIP) system 100, according to an embodiment. The CSIP system 100 includes CSIP proxy 101, having a proxy cache 102 in a local network domain 106. The CSIP proxy 101 is a device with a processor and a storage, such as a home media gateway device, a personal computer, or a server. Devices 103 and 104, are devices for sharing content, such as home devices like cable televisions, smart phones, personal computers, and the like. Devices 103 and 104 are also in the local network domain 106. Devices 103-105 can be any electronic device that share content, such as mobile devices, home entertainment devices, such as DVD players or televisions, or also personal computers, and the like. The CSIP proxy 101 communicates with devices 103 and 104 using CSIP messages 114 and 115, respectively. FIG. 1 also shows that CSIP proxy 101 may also communicate with device 105 using CSIP messages 116. Unlike devices 103 and 104, device 105 is outside the local network domain 106, but may still be involved in an authorization process to share content with devices 103 or 104. On a local network, a domain is a sub network made up of a group of clients and servers under the control of one central security source known as a domain controller.

The CSIP proxy 101 is used within the local network domain 106, which may include a home network, to improve the capability of devices 103 and 104 to efficiently accomplish device certificate revocation status checking without the need for downloading large CRLs 119-121, into the local network domain 106 or into the devices 103 and 104. The CSIP proxy 101 can be any device or computer which can function as home media gateway or home domain controller (HDC) device. The CSIP proxy 101 acts as an HDC for all the devices within the local network domain 106. The CSIP proxy 101 receives a CSIP message from a first device, for instance, the device 103. The CSIP message is one of the CSIP messages 114 and typically contains the certificate identity information of a certificate from a second device, such as the device 105 or the device 104. The device 103 requires the certificate from second device, to be validated through a device certificate revocation status verification process before the device 103 can share content or engage in communication with a second device for sharing content. Note that the second device may be a device inside the local network domain 106, such as the device 104, or the second device may be outside the local network domain 106, such as the device 105.

Each of the devices 103-105 may operate under the same standard, for certificate format purposes, such as all being a certificate format determined by a Digital Transmission Content Licensing Administrator (DTLA)_for either DLNA or DTCP, or under a separate standard for the certificates for each device, such as the format ITU-T X.509 for certificates, which is the X.509 format set by the Telecommunication Standardization Sector (ITU-T). The X.509 format is an ITU-T standard for a public key and specifies the standard format for public key certificates, certificate revocation lists (CRLs), etc. In addition, the devices 103-105 can also function to operate with a unique CSIP proprietary or standard developed for the CSIP system, or with an existing standard such as the Online Certificate Status Protocol (OCSP), which can function as the CSIP mechanism, however the CSIP mechanism in the CSIP system is not limited to OCSP. The OCSP is an internet protocol developed through the ITU-T and used for obtaining the revocation status of an X.509 format digital certificate. New devices, as they are added to the local network domain 106 are attached to the CSIP proxy so that all devices in the local network domain 106 that need certificate status checking can access the CSIP proxy 101 and execute CSIP messaging anytime the device certificate revocation status verification process is required.

The CSIP proxy 101 maintains the proxy cache 102 or some other form of storage, for storing certificate status information at the CSIP proxy 101. In the event a certificate status information is not available in the proxy cache 102 for a specific certificate, such as when the new device 105 is introduced from outside the local network domain 106, the CSIP proxy 101 can access the CSIP responder 107 for the needed certificate status information to complete the device certificate revocation status verification process before first device 103 can share content with the second device.

The CSIP system 100 shown in FIG. 1 also includes a CSIP responder 107, located outside the local network domain 106. The CSIP responder 107 accepts a CSIP request 117 from the CSIP proxy 101. The CSIP request 117 includes certificate identity information (or the certificate itself) for a certificate undergoing the device certificate revocation status verification process. The certificate identity information can be a serial number along with the information that identifies the issuer of the certificate (such as information on issuer name) or some other type of certificate identification, that uniquely identifies the certificate. After obtaining the needed certificate status information, the CSIP responder 107 sends a CSIP response 118 to the CSIP proxy 101. The CSIP response is a communication containing the certificate status information as well as other data fields determined by the CRL or other source of certificate status information, and can include other data fields defined by the CSIP responder as described in more detail below. The CSIP responder 107 may obtain certificate status information from a number of sources. For instance, it accepts updated CRLs 119, 120 and 122 from CRL servers 108, 109 and 110, respectively. These can be CRLs for certificates formatted under the same or different standards. In addition, CSIP responder 107 may send an inquiry for a CRL to a CRL server, such as CRL request 121 sent to the CRL server 109 or receive fresh CRLs from a CRL server as they are generated by the CRL server based on revocation incidents or on periodic basis.

The CSIP responder 107, receives an authorization 123 from a root certificate authority (CA) 111, to act as a source of trust regarding the CRLs 119-121. This may be in form of a signing key that is certified by the root certificate authority (CA) 111. In addition to receiving the CRLs 119-121 as a source for updated certificate status information, the CSIP responder 107 may also communicate with different Certificate Authorities (CAs), such as a CA 112 by sending a request 125 to the CA 112 for a certificate status 124, which the CSIP responder 107 receives in the CSIP response 118 from the CA 112. Similarly, the CSIP responder 107 communicates with a Certificate Licensing Authority (CLA) 113 by sending a request 127 to the CLA 113 for a certificate status 126, which it receives in a response from the CLA 113.

The CSIP responder 107 converts the certificate status information to a uniform CSIP format. The CSIP format can be the OCSP format, or another format that is a derivative of or similar to the OCSP format. These CSIP/OCSP formats can used for storage at the CSIP responder 107, at the CSIP proxy 101, and can be the format used in CSIP requests 117 and CSIP responses 118. One example of CSIP/OCSP requests/responses using an OCSP format can be an extension of IETF defined (RFC 5019, described further below) OCSP (defined for ITU-T X.509 certificate format) for the DTCP (DTLA) certificate format. Specific examples of other CSIP formats for the CSIP response 118 and the CSIP request 117 follow below.

### 2. EXAMPLES

### Example 1

### CSIP or OCSP Format for the CSIP Request 117 Extended for Use with DTLA Issued Certificates

CSIP/OCSP requests based on RFC 5019, another protocol based on and similar to the OCSP protocol, like the RFC 2560 protocol, can be defined as follows. RFC 5019 does not allow the requester to request the status for more than one certificate at a time. The CSIP request 117 is not signed and thus the identity of the requestor is not included in the request either.

In order to be as compatible as possible to the Internet Engineering Task Force (IETF) specifications, the use of DTLA-specific extensions for the CSIP request 117 and response 118 can be avoided. Instead the CSIP responder 107 relies on the issuer name and issuer public key hash to determine that it involves a DTLA certificate. This is explained further below. Furthermore, to adopt use of standard OCSP messaging to DTLA certificates, which may not include a certificate serial number as the certificate identity information, a unique device ID within the DTLA certificate can be used instead of the certificate serial number in the CSIP request 117 and response 118. As DTLA certificates are issued by the same issuer, the Digital Transmission Licensing Authority, with the same issuer name and public key, the following convention can be used for the issuer name and the issuer public key. Issuer Name: “Digital Transmission Licensing Authority”, Issuer key: DTLA public key provided to the DTLA adopters through DTLA licensing agreement. One of issuer name or issuer public key or both are used along with the identified hash algorithm to provide the issuer Name Hash and/or issuer Key Hash within the CSIP/OCSP request/response messages.

Table 1 below gives examples of data fields in a CSIP request, such as the CSIP request 117 shown in FIG. 1.

TABLE 1
Examples of Data Fields in a CSIP Request

| Field Name | RFC2560 type | Value |
|---|---|---|
| tbsRequest { | SEQUENCE | OCSP request |
| version | INTEGER | v1 |
| requestorName | General Name | Name of signer, included if |
| | | the OCSP request is signed. |
| | | Not included otherwise. |
| requestList { | SEQUENCE | OCSP requests compliant to |
| | OF | RFC 5019 profile include only |
| | | one entry |
| reqCert { | SEQUENCE | Identifies the certificate, |
| | | whose status is being |
| | | requested. |
| hashAlgorithm | Algorithm | Identifies hash algorithm |
| | Identifier | (typically SHA1) used for |
| | | calculation of hashes of |
| | | issuer's name or key. |
| issuerNameHash | OCTET | Hash of issuer's name. |
| | STRING | |
| issuerKeyHash | OCTET | Hash of issuer's key. |
| | STRING | |
| serialNumber | INTEGER | Certificates's serial number |
| } } | | for which status information |
| | | is requested. |
| | | Use DTLA assigned DeviceID |
| | | of the certificate as |
| | | serialNumber. |
| optionalSignature | | RFC 5019 recommends |
| { | | against signing OCSP |
| | | requests. |
| signatureAlgorithm | AlgorithmIdentifier | Identifies signature algorithms |
| | | used to sign the OCSP request |
| | | (this is for RFC 2560 profile). |
| signature | BIT STRING | Signature value |
| certs | SEQUENCE | Certificate necessary to verify |
| | OF Certificates | digital signature on the OCSP |
| | | request |

In the exemplary data fields above, the “tbsRequest” is identified as an OCSP request, the “requestorName” is the name of signer, which is included if the OCSP request is signed, but generally not included otherwise. The “requestList” identifies that the OCSP requests are compliant to RFC 5019 profile and include only one entry, the “reqCert” identifies the certificate, whose status is being requested, the “hashAlgorithm” identifies the hash algorithm, typically SHA1, used for calculation of the hashes of the issuer's name or key, the “issuerNameHash” is the hash of issuer's name, the “issuerKeyHash” is the hash of issuer's key. The “serialNumber” is the certificate serial number. Typically this is the certificate identity information, for which status information is requested. The “optionalSignature” may not be used as the RFC 5019 protocol recommends against signing OCSP requests The “signatureAlgorithm” identifies the signature algorithms used to sign the OCSP request. The “signature” is typically the signature value. The field labeled “certs” is the certificate necessary to verify digital signature on the OCSP request. When using the DTLA standard, the assigned Device ID of the certificate can be used as the serial number.

### Example 2

### OCSP Response According to RFC 5019

Table 2 below gives examples of data fields in a CSIP response, such as the CSIP response 118 shown in FIG. 1.

TABLE 2
Examples of Data Fields in a CSIP Response

| Field Name | RFC2560 type | Value |
|---|---|---|
| tbsResponseData | SEQUENCE | |
| { | | |
| version | INTEGER | v1 |
| responderID | CHOICE | Hash (e.g. SHA1) of |
| | | responder's public key. |
| producedAt | Generalized Time | |
| responses { | SEQUENCE OF | SHOULD include only one |
| | | entry per RFC 5019. |
| | | However more than one |
| | | response is allowed if |
| | | performance of pre- |
| | | generation or caching is |
| | | improved. |
| certID { | | |
| hashAlgorithm | AlgorithmIdentifier | Identifies hash algorithm. |
| | OCTET STRING | Hash of issuer's name. |
| issuerNameHash | | |
| issuerKeyHash | OCTET STRING | Hash of issuer's key. |
| serialNumber } | INTEGER | Certificates's serial number |
| | | for which status information |
| | | is returned. |
| | | Use DTLA assigned |
| | | DeviceID of the certificate as |
| | | serialNumber. |
| certStatus | | good, revoked, or unknown |
| thisUpdate | GeneralizedTime | Time when the status is |
| | | known to be correct. |
| nextUpdate | GeneralizedTime | Time at which or before new |
| | | information will be available. |
| singleExtensions | | MAY NOT be present in this |
| } | | example |
| responseExtensions | | MAY NOT be present in this |
| | | example |
| signatureAlgorithm | AlgorithmIdentifier | Identifies signature |
| | | algorithms. |
| signature | BIT STRING | Signature value |
| certs | SEQUENCE OF | Certificate necessary to |
| | Certificates | verify digital signature. |

In the exemplary data fields above, the “tbsResponseData” is identified as response data fields to be signed, the “responderID” is the hash of responder's public key. The “producedAt” identifies signing time, the “responses” identifies responses on certificate/s in which the status is being verified and should include only one entry per RFC 5019. However more than one response is allowed if performance of pre-generation or caching is improved. the certificate, whose status is being requested, the “certID” identifies certificate in which the status is verified, the “hashAlgorithm” identifies the hash algorithm, typically SHA1, used for calculation of the hashes of the issuer's name or key, the “issuerNameHash” is the hash of issuer's name, the “issuerKeyHash” is the hash of issuer's key. The “serialNumber” is the certificate serial number for which status information is returned. Typically this is the certificate identity information, for which status information is returned. In DTLA the assigned Device ID of the certificate is used as the serial number. The “certStatus” is the value indicating the certificate is either good, revoked or unknown. The “thisUpdate” is the value indicating the time when the status is known to be correct. The “nextUpdate” is the value indicating the time when at which or before new information will be available. The “singleExtensions” and “responseExtensions” identify extensions included in requests and responses and, and neither are present. The “signatureAlgorit” identifies the signature algorithms used to sign the OCSP request. The “signature” is typically the signature value. The field labeled “certs” is the certificate necessary to verify digital signature on the OCSP request.

### Example 3

### DLNA/UPnP Device Discovery Extension for Advertising OCSP Capabilities

Device discovery and control enables a device on the home network to discover the presence and capabilities of other devices on the network and collaborate with these devices in a uniform and consistent manner. As part of device discovery, a device capability is a set of device functions (at least one) aggregated to be used in a CSIP system usage that enables home networking use case scenarios. A device capability does not provide support for all layers in the DLNA architecture. An example of a device capability is any DLNA device that incorporates the additional feature (capability) of pushing content to a rendering device, such as a “Push Controller”.

### 3. METHODS

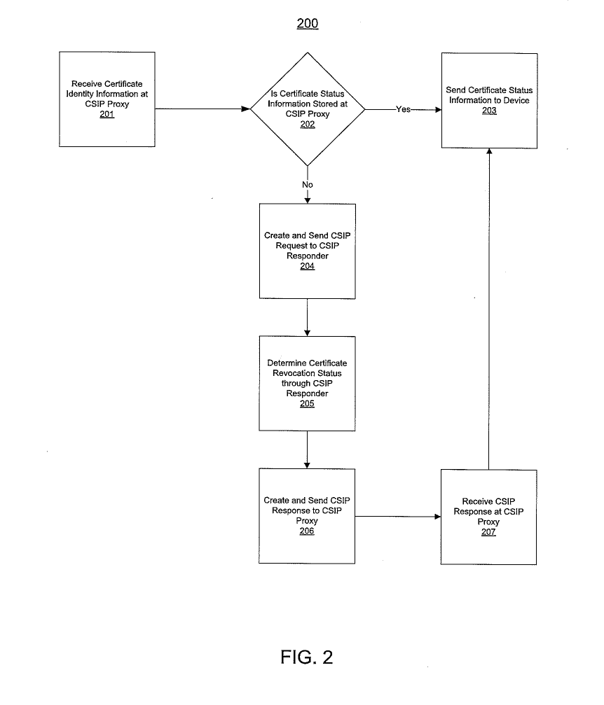

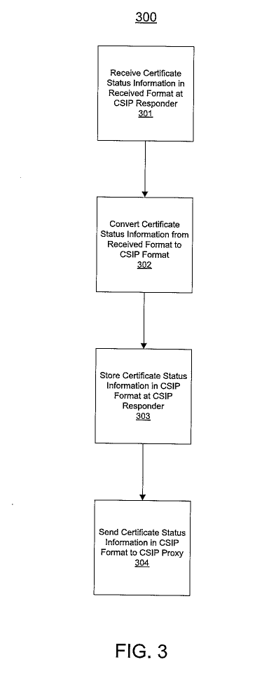

FIG. 2 illustrates method 200 for providing certificate status information, according to an embodiment. FIG. 3 illustrates method 300 for providing certificate status information, according to another embodiment. The methods 200 and 300 are described with respect to the system shown in FIG. 1, by way of example and not limitation, and the methods may be performed in other systems.

Method 200 in FIG. 2 illustrates a method for providing certificate status information for a certificate of a second device, through a CSIP proxy, to a first device.

At step 201, the CSIP proxy 101 receives a CSIP message from a first device including a certificate identity information for a certificate of a second device in a CSIP request for the certificate status information.

At step 202, the CSIP proxy 101 determines whether the certificate status information sought in the CSIP message is stored in the proxy cache 102.

At step 203, if the certificate status information is stored in the proxy cache 102, the CSIP proxy 101 sends a CSIP message, including the certificate status information, back to the first device.

At step 204, if the certificate status information is not stored in the proxy cache 102, the CSIP proxy 101 creates and sends a CSIP request 117, including the certificate identity information, to the CSIP responder 107.

At step 205, the CSIP responder 107, determines the certificate revocation status of the certificate associated with the certificate identity information in the CSIP request. The CSIP responder 107 makes this determination using the certificate identity information and Certificate Revocation Lists (CRLs) received at the CSIP responder 107 or by accessing a Certificate Authority (CA) for the certificate status information.

At step 206, the CSIP responder 107 creates and sends a CSIP response 118 to the CSIP proxy 101. The CSIP response 118 includes the certificate status information for the certificate of the second device.

At step 207, the CSIP proxy 101 receives the CSIP response 118, including the certificate status information for the certificate of the second device, which is forwarded to the first device in a CSIP message according to step 203, as described above.

Method 300 in FIG. 3 illustrates a method for providing certificate status information, in a CSIP format, taken from various sources of certificate status information in other certificate formats, to a CSIP proxy 101, through a CSIP responder 107.

At step 301, the CSIP responder 107 receives certificate status information in various received formats from different CRL servers, 108-110, CA 112 and CLA 113.

At step 302, the CSIP responder 107 converts the received certificate status information to a uniform CSIP format from the various received formats from different CRL servers, 108-110, CA 112 and CLA 113.

At step 303, the CSIP responder 107 stores the converted certificate status information in the CSIP format.

At step 304, the CSIP responder 107 sends a CSIP response 118 to the CSIP proxy 101 including the converted certificate status information in the CSIP format.

### 4. COMPUTER SYSTEMS

### CSIP Proxy and/or CSIP Responder

One or more of the steps and functions described herein and one or more of the components of the systems described herein may be implemented as computer code stored on a computer readable storage device, such as memory or another type of storage device. The computer code is executed on a computer system (e.g., the computer system 400 described below), for example, by a processor, application-specific integrated circuit (ASIC), or other type of circuit. The code may exist as software program(s) comprised of program instructions in source code, object code, executable code or other formats.

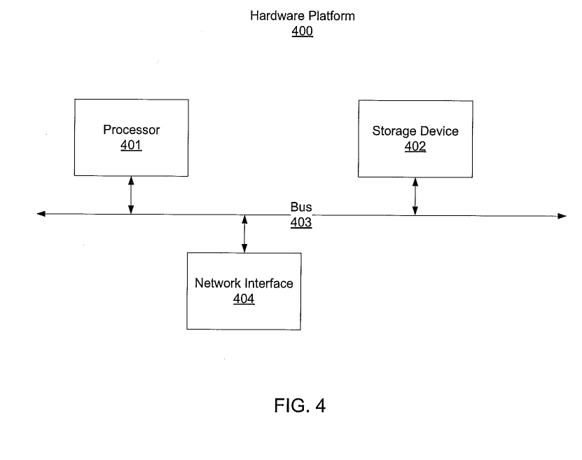

FIG. 4 shows a computer system 400 that may be used as a hardware platform for either the CSIP proxy 101 or the CSIP responder 107. The computer system 400 may be used as a platform for executing one or more of the steps, methods, and functions described herein that may be embodied as software or computer readable medium stored on one or more computer readable storage devices, which are hardware storage devices.

The computer system 400 includes a processor 401 or processing circuitry that may implement or execute software instructions performing some or all of the methods, functions and other steps described herein. Commands and data from the processor 401 are communicated over a communication bus 403. The computer system 400 also includes a computer readable storage device 402, such as random access memory (RAM), where the software and data for processor 401 may reside during runtime. The storage device 402 may also include non-volatile data storage. The computer system 400 may include a network interface 404 for connecting to a network. It is apparent to one of ordinary skill in the art that other known electronic components may be added or substituted in the computer system 400.

The systems and method described herein provide the advantage of allowing the use of a Certificate Status Information Protocol (CSIP) proxy device within a local network to improve the capability of device certificate revocation status checking for devices in a local network without a need for downloading large CRLs into the local network for the devices in the network. The embodiments also provide the advantage of removing the need for regular or constant connectivity, of devices in the local network, to the Internet and/or to other infrastructure, which is external to the local network for providing CRLs, such as a CRL server. This also reduces the significant delays associated with two-way communications between a device and a CRL server. Embodiments directed to a CSIP proxy including a CSIP proxy memory also provide the advantage of reducing the level of connectivity to the CSIP responder, by using the certificate status information in CSIP proxy memory for at least part of the certificate revocation status verification process, rather than accessing the CSIP responder. Another advantage relates to the use of CSIP protocol for enhancing the communications involving certificates based on different standards, such as DTCP and DNLA.

While the embodiments have been described with reference to examples, those skilled in the art are able to make various modifications to the described embodiments without departing from the scope of the embodiments as described in the following claims, and their equivalents.

What is claimed is:

1. A Certificate Status Information Protocol (CSIP) proxy device in a local network domain, configured to provide, through the local network domain to a first device in the local network domain, a second device certificate status information about a certificate of a second device, the CSIP proxy device comprising:
a data storage device configured to store, for a plurality of devices, a certificate status information about certificates of the plurality of devices; and
a processor configured to
receive, from the first device, a second device certificate identity information about the certificate of the second device;
determine whether the second device certificate status information is stored in the data storage device,
if the second device certificate status information is not stored in the data storage device, create a CSIP request based on the second device certificate identity information and send the CSIP request to a CSIP responder computer outside the local network domain; and
if the second device certificate status information is stored in the data storage device, send the second device certificate status information to the first device.

2. The CSIP proxy device according to claim 1, wherein the second device is out of the local network domain.

3. The CSIP proxy device according to claim 1, wherein the CSIP proxy device uses the Online Certificate Status Protocol (OCSP) as an internet protocol for communicating with the CSIP responder computer.

4. The CSIP proxy device according to claim 1, wherein the processor is configured to:
receive a CSIP response including the second device certificate status information from the CSIP responder computer.

5. The CSIP proxy device according to claim 4, wherein the processor is configured to:
store, in the data storage device, the second device certificate status information in the CSIP response from the CSIP responder computer.

6. The CSIP proxy device according to claim 4, wherein the processor is configured to:
store, in the data storage device, the CSIP response, including the second device certificate status information, from the CSIP responder computer.

7. The CSIP proxy device according to claim 4, wherein the processor is configured to:
receive, from the CSIP responder computer, the second device certificate status information based on a pre-configured policy.

8. The CSIP proxy device according to claim 7, wherein the processor is configured to:
request, from the CSIP responder computer, the second device certificate status information, on a periodic basis or, in response to or in anticipation of, a change in the second device certificate status information.

9. A method for providing, through a local network domain to a first device in the local network domain, a second device certificate status information about a certificate of a second device, the method comprising:
receiving, at a Certificate Status Information Protocol (CSIP) proxy device in the local network domain, a second device certificate identity information about the certificate of the second device;
determining, using the CSIP proxy device, whether the second device certificate status information is stored in a CSIP proxy device memory,
if the second device certificate status information is not stored in the CSIP proxy device memory, creating a CSIP request based on the second device certificate identity information and sending the CSIP request, to a CSIP responder computer outside the local network domain, and
if the second device certificate status information is stored in the CSIP proxy device memory, sending the second device certificate status information to the first device.

10. The method according to claim 9, wherein the CSIP responder computer receives the CSIP request from the CSIP proxy device;
determines, using the certificate identity information, a Certificate Revocation List (CRL) or a Certificate Authority (CA) for providing the second device certificate status information including a revocation status of the certificate and obtains the second device certificate status information including the revocation status from the determined CRL or the CA;
creates a CSIP response including the second device certificate status information; and
sends the CSIP response from the CSIP responder computer to the CSIP proxy device.

11. The method according to claim 10, further comprising:
receiving the CSIP response from the CSIP responder computer at the CSIP proxy device.

12. The method according to claim 11, wherein different CRLs and different CAs provide a plurality of certificate status information for a plurality of certificates in different formats.

13. The method according to claim 11, further comprising:
storing, in the CSIP proxy device memory, the second device certificate status information in the CSIP response from the CSIP responder computer.

14. The method according to claim 11, further comprising:
storing, in the CSIP proxy device memory, the CSIP response, including the second device certificate status information from the CSIP responder computer.

15. The method according to claim 9, wherein the second device is out of the local network domain.

16. The method according to claim 9, wherein the CSIP proxy device uses the Online Certificate Status Protocol (OCSP) as an internet protocol for communicating with the CSIP responder computer.

17. The method according to claim 10, further comprising:
receiving, from the CSIP responder computer a second CSIP response including a second CSIP response certificate status information, based on a pre-configured policy.

18. The method according to claim 10, further comprising:
requesting, from the CSIP responder computer a second CSIP response including a second CSIP response certificate status information, on a periodic basis or, in response to or in anticipation of a change in the second CSIP response certificate status information as stored in the CSIP responder computer.

19. A Certificate Status Information Protocol (CSIP) responder computer outside a local network domain, configured to provide a CSIP response including a certificate status information, to a CSIP proxy device in the local network domain, the CSIP responder computer comprising:
a data storage device configured to store, for a plurality of devices inside a plurality of local network domains, a plurality of certificate status information about a plurality of certificates for the plurality of devices in the plurality of local network domains; and
a processor configured to
receive from a Certificate Licensing Authority (CLA), a Certificate Revocation List (CRL) or a Certificate Authority (CA), the plurality of certificate status information about the plurality of certificates, wherein the received plurality of certificate status information are in a format determined by the CLA, the CRL or the CA;
convert the received plurality of certificate status information from the received individual format to a CSIP format certificate status information;
store the CSIP format certificate status information in the data storage device; and
send the CSIP format certificate status information in a CSIP response to the CSIP proxy device in the local network domain.

20. The CSIP responder computer according to claim 19, wherein the processor is configured to send the CSIP response in response to a CSIP request from the CSIP proxy device.

21. The CSIP responder computer according to claim 19, wherein the processor is configured to:
send the CSIP response based on a pre-configured policy.

22. The CSIP responder computer according to claim 19, wherein the processor is configured to:
send the CSIP response, on a periodic basis or, in response to or in anticipation of, a change in a certificate status information from the Certificate Licensing Authority (CLA), the Certificate Revocation List (CRL) or the Certificate Authority (CA).

23. The CSIP responder computer according to claim 19, wherein the CSIP responder computer uses the Online Certificate Status Protocol (OCSP) as an internet protocol for communicating with the CSIP proxy device.

24. A method for providing a certificate status information about a certificate of a device to a Certificate Status Information Protocol (CSIP) proxy device in a local network domain, the method comprising:
locating a Certificate Licensing Authority (CLA) or a Certificate Authority (CA), responsible for providing a Certificate Revocation List (CRL) or other revocation information for the certificate,
receiving from the CLA or CA, a CRL, including the certificate status information about the certificate, wherein the received certificate status information is in a format determined by the CLA, the CA or the CRL;
converting the received certificate status information from the received format to a CSIP format;
storing the CSIP format certificate status information in a CSIP responder computer memory; and
sending the CSIP format certificate status information in a CSIP response to the CSIP proxy device in the local network domain.

25. The method according to claim 24, wherein the CSIP response is sent in response to a CSIP request from the CSIP proxy device.

26. The method according to claim 24, further comprising:
sending a second CSIP response based on a pre-configured policy.

27. The method according to claim 24, further comprising:
sending a second CSIP response, on a periodic basis or, in response to or in anticipation of, a change in the certificate status information from a second Certificate Licensing Authority (CLA), a second Certificate Revocation List (CRL) or a second Certificate Authority (CA).

28. The method according to claim 24, wherein the CSIP responder computer uses the Online Certificate Status Protocol (OCSP) as an internet protocol for communicating with the CSIP proxy device.
